(19) United States
(12) Patent Application Publication
(10) Pub. No.: US 2018/0186125 A1
(43) Pub. Date: Jul. 5, 2018

(54) AUTOMOTIVE LAMINATED GLAZING WITH ENHANCED SPECTRAL PROPERTIES USING BAND ABSORPTION DYES

(71) Applicant: AGP América S.A., Panama City (PA)

(72) Inventors: Mario Arturo Mannheim Astete, Lima (PE); Philip Denton Gordon, Lima (PE)

(21) Appl. No.: 15/859,423

(22) Filed: Dec. 30, 2017

Related U.S. Application Data
(60) Provisional application No. 62/440,448, filed on Dec. 30, 2016.

(51) Int. Cl. B32B 17/10

(52) U.S. Cl. CPC B32B 17/10339; B32B 17/10678; B32B 2605/006; B32B 17/10036; B32B 2307/42; B32B 17/10651

(57) ABSTRACT

The present invention provides for a laminate that utilizes the ability of a narrow band absorbing dyes to absorb selective wavelengths of light by identifying a color target and tuning to that target. Working with just glass compositions, coatings, interlayers and films, all of which act as broad band filters, it is difficult to fine tune the spectral response of a laminate. Narrow band absorbing dyes are used to selectively tune the spectral response to achieve targeted performance in the UV, visible and IR ranges of the spectrum.

### CROSS-REFERENCE TO RELATED APPLICATIONS

This application claims the benefit, under 35 U.S.C. § 119(e)(1), of provisional patent application Ser. No. 62/440,448 titled “Automotive laminated glazing with enhanced spectral properties using band absorption dyes,” which was filed on Dec. 30, 2016, by the same inventors of this application. The aforementioned provisional application is incorporated herein by reference in its entirety, as if it were disclosed in the present document.

### FIELD OF INVENTION

The present invention relates generally to the field of laminated glazing using optical narrow band absorption dyes.

### BACKGROUND OF THE INVENTION

The various glass compositions, interlayers, films and coatings, used to improve solar control, reduce weight and add other features in laminated glass, may shift visible color, the white point, towards a less desirable aesthetic. This is because these materials act as optical broad band filters. As such, they typically are active over a broad range with a low slope leading to less than desired response especially in the transition areas.

Limited options exist for controlling and adjusting the spectral response. Working with just the glass compositions, coatings, interlayers and films it is difficult to fine tune the spectral response of a laminate within a narrow band of the spectrum. The final result is often a compromise between performance, aesthetics and regulatory compliance. As can be appreciated, means for fine tuning of the spectral response would enhance both performance and aesthetics.

### SUMMARY OF THE INVENTION

It is an object of this invention to provide a laminate with enhanced spectral properties.

This object can be attained by a laminate comprising at least two glass layers, at least one plastic interlayer, and at least one narrow band absorbing dye; wherein said at least one plastic interlayer is positioned between major surfaces of each adjacent pair of glass layers of the at least two glass layers and serving to bond said glass layers to each other, and said at least one narrow band absorbing dye is applied to at least a portion of the vision area of the laminate.

### DESCRIPTION OF DRAWINGS

FIG. 1 shows examples of spectral responses of a first set of narrow absorbing dyes;

FIG. 2 shows examples of spectral responses of a second set of narrow absorbing dyes;

FIG. 3 shows examples of spectral responses of a third set of narrow absorbing dyes;

FIG. 4 shows examples of spectral responses of a fourth set of narrow absorbing dyes;

FIG. 5 shows a cross section of a typical laminate;

FIG. 6 shows a cross section of the laminate of the present invention with film.

### GUIDE TO THE NUMBERS

1 Surface one
2 Surface two
3 Surface three
4 Surface four
5 Glass layer
6 Plastic Interlayer
7 Film

### DETAILED DESCRIPTION OF THE INVENTION

The present invention refers to a laminate which uses narrow band absorbers to fine tune and adjust the spectral response of the laminate.

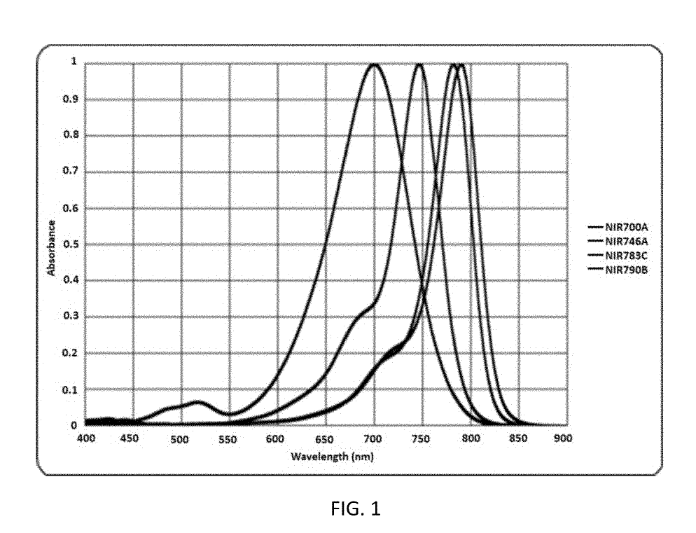

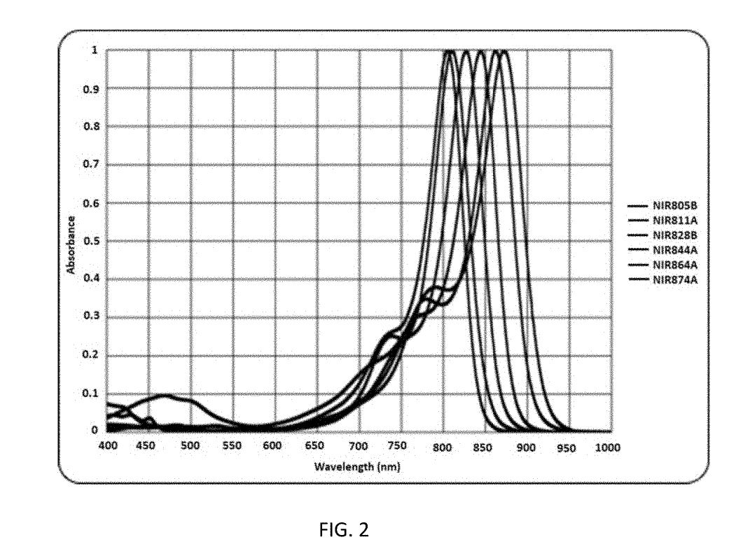

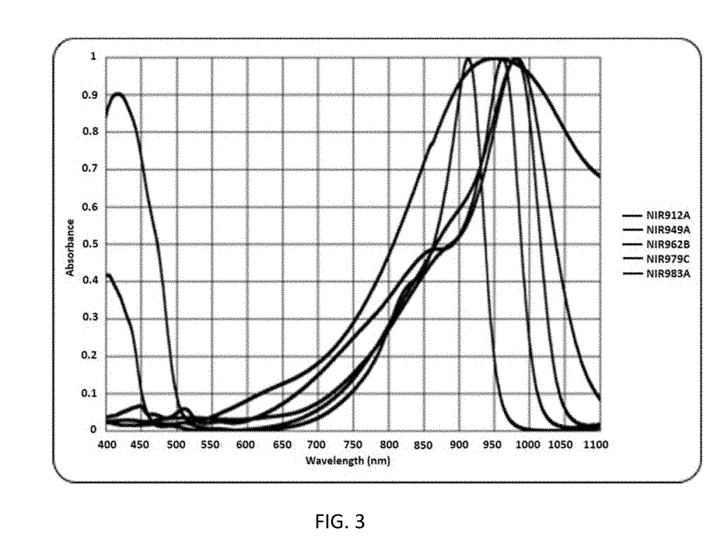

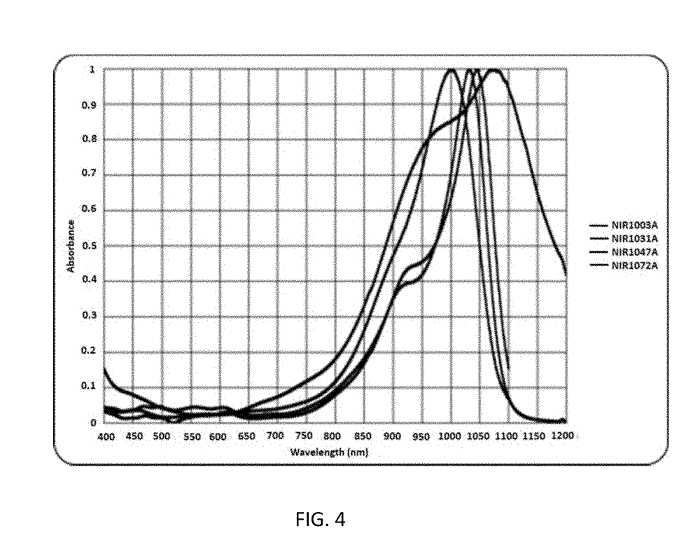

Narrow band absorbers, with absorption bands as narrow as 10 nm, filter out light with low visible color even at high optical densities. Some examples of the spectral response are shown in FIGS. 1-4. These narrow band absorption dyes are used to create selective wavelength filters. These filters are used in LASERs, camera lenses, eye glasses and in security applications. The present invention may combine multiple absorbers to customize the shape of the absorption. Narrow band absorbers can also be used in conjunction with broad band absorbing dyes to create sharp cut-off, long pass filters.

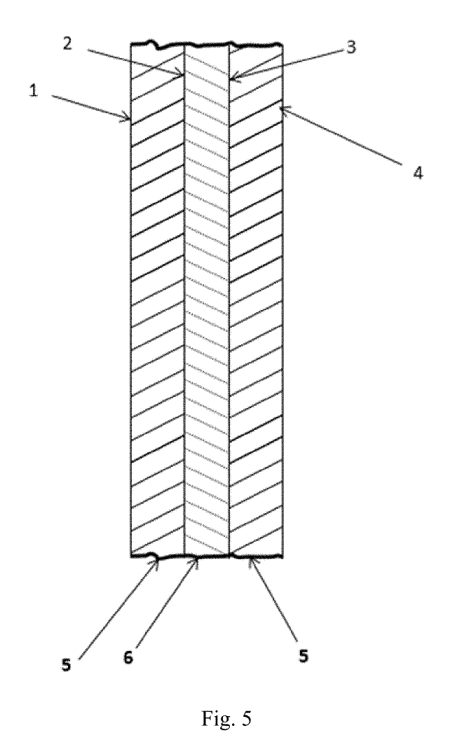

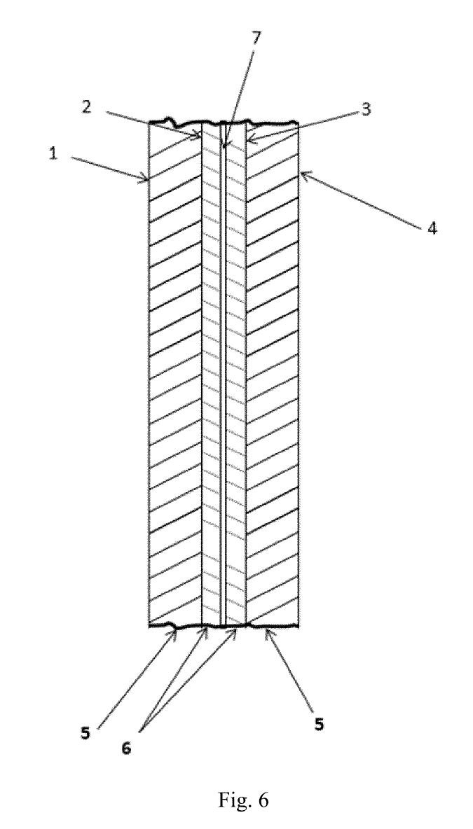

As shown in FIGS. 5-6, standard terminology is used to describe the configuration of a laminate, wherein a normal automotive windshield is comprised of two layers of glass 5, which are permanently bonded together with a plastic interlayer 6. The glass layer surface that is on the outside of the vehicle is referred to as surface one 1. The opposite face of the surface 1 is surface two 2. The glass surface that is on the inside of the vehicle is referred to as surface four 4. The opposite face of the surface four 4 is surface three 3.

Referring to FIG. 5, it is shown a laminated glass comprised of an assembly of at least two glass layers 5 which are bonded together using at least one plastic interlayer 6.

In one embodiment of the present invention, as shown in FIG. 6, the plastic interlayers can also include a film layer 7 positioned between the major surfaces of two thermo-plastic interlayers 6. A film 7 is defined to include but is not limited to: polyester (PET), polymer dispersed liquid crystal (PDLC), suspended particle device (SPD), coated solar control film, electro-chromic film (EC) or a tinted film.

Narrow band absorbers are available in forms that can be mixed with solvents or water and that can be dispersed within plastics. Multiple means for application of this type of bands can be applied by spray or any other suitable means known in the art, of a water or solvent based carrier to the glass 5 or plastic interlayers 6.

Alternately, the dye can be mixed in with the plastic 6 prior to forming the plastic interlayer. In this manner, the narrow band absorbers can be applied, in any combination, as a coating to any of the glass or plastic surfaces (1, 2, 3, or 4) or dispersed in the plastic interlayers. The dyes can be incorporated such as to cover the entire area of the vision area of the laminate or a selective portion. In a preferred embodiment, a narrow band absorbing dye is positioned in the camera field of view of a laminate, i.e. the portion of a laminate aligned with a camera such that the camera views through the laminate via that portion.

Multiple applications cross section can be applied for the present invention, such as for automotive glazing is a windshield. In such applications, a combination of narrow band and broad band absorbing dyes can be configured to filter or more accurately attenuate visible light in multiple or single combinations of spectral bands.

This alone or in combination with technologies such as glass coatings, films, interlayers and glass compositions constitutes a novel optical filter. The filter is comprised of any number of dyes applied to any combination of surfaces of the glass and plastic surface and/or dispersed in any combination of the plastic interlayers.

Highly thermally stable, narrow band, visible light absorbing dyes can be used to selectively tune color in automotive glazing. Narrow band absorbers have been of interest for some time due the high exciton diffusion coefficient properties and the very specific tunable wavelength absorption, some with characteristics as low as 10 nm at half-mast and some with characteristics as wide as 100 nm at half-mast. In this particular instance, the present invention may use the narrow wavelength absorptions as a method of selectively tuning color without compromising total visible light (Tvis) into the vehicle.

The laminate of the present invention utilizes the ability of the narrow band absorber to absorb selective wavelengths of light by identifying a color target and tuning to that target. At the same time this allows more total visible light to enter through the total glazing that with a broad band filter. This provides more flexibility to use more absorbers at different wave lengths and/or to mix these absorbers with broad band absorbers to attain our final desired effect and create an optical filter.

In applications where tuning color is particularly difficult, as when the selected components of the laminate have a function driven “lock” on a certain range of bandwidths, tuning can become very difficult if not impossible with broad band absorbers. Variable light transmission products like SPD, PDLC, or EC often exhibit these properties. Using a lot of the available visible spectrum and coming close to the total allowable Tvis color correction or tuning colors to specific client requests can become impossible.

In example, a variable transmission film has a functional “Lock’ on 450 nm to 525 nm causing the final product to be a very bold blue. With a narrow band absorber placed at 475 nm with a very narrow peak in the range of 30 nm at half-mast, that peak could absorb blue light and shift the apparent or observed color to the orange side of the spectrum, all the while still fitting within the tight specifications of total Tvis.

The secondary effect of this is an apparent white point shift in the vision of the observer, giving rise to natural color and hue enchantments that can also be targeted or selectivity tuned if so desired. For instance, the front glazing windshield of fleet vehicles could be enhanced to more readily detect orange and red safety signs or systems in certain lighting conditions such as dusk or dawn.

Another application for this type of absorber is solar performance, or additional solar performance. The volume of energy in the visible spectrum peaks near 500 nm. Using a narrow band absorption with a 500 nm peak will significantly reduce the total solar load (Tsol) and allow the secondary use of other technologies such as silver coatings or films without sacrificing totalTvis. Using a narrow band absorber that showed both a main peak at 600 nm and a secondary peak at 350 nm would help create a virtual notch filter that could be filled in by a broad band absorber or by additional technologies that could be reflective or absorbing in nature.

In preferred embodiments, a laminate includes at least one narrow band absorbing dye having a bandwidth substantially in the range selected from the group consisting of IR, UV and visible. Additionally, in some embodiments, a laminate includes at least one narrow band absorbing dye having a bandwidth selected from the group of 50 nm, 100 nm and 150 nm.

### Advantages

Improved aesthetics (color);
Ability to enhance colors;
Improved solar performance;
Increase visible light without increasing solar load;
Reduce glare.

### EXAMPLES

A windshield including a narrow band absorbing dye, having a bandwidth in the 550 nm range, spray coated on surface two 2 of the glass to improve solar performance and shift the color.

A windshield including a narrow band absorbing dye, having a bandwidth in the 380-420 nm range is dispersed in the interlayer as the interlayer is extruded to protect SPD/PDLC films from UV and near UV.

A windshield including a narrow band absorbing dye, having a bandwidth in the 780-820 nm range, spray coated onto surface two 2 of the glass to improve solar performance.

A windshield including a narrow band absorbing dye having peaks at both 450 and 600 nm is spray coated onto surface two 2 of the glass to shift the white point.

The forms of the invention shown and described in this specification represent illustrative preferred embodiments and it is understood that various changes may be made without departing from the spirit of the invention as defined in the following claimed subject matter.

### REFERENCES

U.S. application Ser. No. 13/029,997, filed Feb. 17, 2011, titled EYEWEAR WITH CHROMA ENHANCEMENT which claims the benefit under 35 U.S.C. § 119(e) of U.S. Provisional Patent Application No. 61/425,707, filed Dec. 21, 2010, titled EYEWEAR AND LENSES WITH CHROMA ENHANCING FILTER, and U.S. Provisional Patent Application No. 61/324,706, filed Apr. 15, 2010, titled EYEWEAR AND LENSES WITH CHROMA ENHANCING FILTER.

1. A laminate comprising:
at least two glass layers,
at least one plastic interlayer, and
at least one narrow band absorbing dye,
said at least one plastic interlayer positioned between major surfaces of each adjacent pair of glass layers of the at least two glass layers and serving to bond said glass layers to each other, and
said at least one narrow band absorbing dye applied to at least a portion of the vision area of the laminate.

2. The laminate of claim 1, wherein said at least one narrow band absorbing dye is applied to at least one of the glass layer surfaces.

3. The laminate of claim 1, wherein said at least one narrow band absorbing dye is applied to at least one of the glass layer surfaces adjacent to a plastic interlayer surface of said at least one plastic interlayer.

4. The laminate of claim 1, wherein said at least one narrow band absorbing dye is applied to at least one plastic interlayer surface of said at least one plastic interlayer.

5. The laminate of claim 1, wherein said at least one narrow band absorbing dye is dispersed through at least a portion of said at least one plastic interlayer.

6. The laminate of claim 1, wherein said at least one plastic interlayer comprises two thermo-plastic interlayers and a film layer, and wherein the film layer is positioned between the major surfaces of the two thermo-plastic interlayers.

7. The laminate of claim 6, wherein the film layer is a PET plastic.

8. The laminate of claim 6, wherein the film layer is a substantially plastic performance film.

9. The laminate of claim 1, wherein the at least one narrow band absorbing dye comprises a narrow band absorbing dye having a bandwidth of 150 nm.

10. The laminate of claim 1, wherein the at least one narrow band absorbing dye comprises a narrow band absorbing dye having a bandwidth of 100 nm.

11. The laminate of claim 1, wherein the at least one narrow band absorbing dye comprises a narrow band dye absorbing having a bandwidth of 50 nm.

12. The laminate of claim 1, wherein the at least one narrow band absorbing dye has a bandwidth substantially in the IR range.

13. The laminate of claim 1, wherein the at least one narrow band absorbing dye has a bandwidth substantially in the visible range.

14. The laminate of claim 1, wherein the at least one narrow band absorbing dye has a bandwidth substantially in the UV range.

15. The laminate of claim 1, wherein the at least one narrow band absorbing dye comprises a narrow band absorbing dye positioned in the camera field of view of the laminate.
